(19) United States
(12) Patent Application Publication
(10) Pub. No.: US 2014/0343963 A1
(43) Pub. Date: Nov. 20, 2014

(54) Dynamic Superbill Coding Workflow

(71) Applicant: MModal IP LLC, Franklin, TN (US)

(72) Inventors: Juergen Fritsch, Pittsburgh, PA (US); Vasudevan Jagannathan, Morgantown, WV (US)

(73) Assignee: MModal IP LLC, Franklin, TN (US)

(21) Appl. No.: 14/218,220

(22) Filed: Mar. 18, 2014

Related U.S. Application Data
(63) Continuation of application No. 14/211,322, filed on Mar. 14, 2014.
(60) Provisional application No. 61/791,127, filed on Mar. 15, 2013.

(51) Int. Cl. G06F 19/00

(52) U.S. Cl. CPC G06F 19/328; G06F 19/322
USPC 705/3

(57) ABSTRACT

A computer system generates an initial set of billing codes based on one or more documents (e.g., clinical notes) representing a patient encounter, such as clinical notes created by a physician. The system expands the initial set of billing codes based on a billing code standard to create an expanded set of billing codes for consideration by the physician. The system provides output representing the expanded billing code set to the physician. The physician selects one or more billing codes from the expanded billing code set for inclusion in a final billing code set for use in a bill for the services provided in the patient encounter.

### BACKGROUND

After physicians and other healthcare professionals (referred to herein generally as “healthcare providers”) provide healthcare services to patients, bills for such services must be generated. The process of generating such bills can be a tedious, time-consuming, risky, and error-prone process for a variety of reasons, such as:
Laws, regulations, and institutional policies prescribe that bills satisfy various rules, such as rules requiring that each item in a bill be justified by adequate supporting evidence. Such rules can be difficult to identify and interpret, and the required evidence can be difficult to find and evaluate.
Bills must be encoded using billing codes specified by technical billing code standards such as ICD-9, ICD-10, and CPT. Such standards can be difficult to understand and apply in particular situations in light of the services provided and the available evidence. Furthermore, as older standards (such as ICD-9) are replaced with newer, more complex, standards (such as ICD-10), the difficulty of understanding the applicable standards is increasing.
Bills often must be generated quickly due to time and budget constraints.
The error rate in bills, including both false positives and false negatives, must be kept to a minimum. False positives (including items in bills that should not be included, such as because they are not justified by available evidence) may violate applicable laws, regulations, and/or institutional policies. False negatives (failing to include items in bills that should be included) lead to lost revenue for the healthcare provider.
The person who generates a particular bill may lack one or more kinds of expertise needed to generate the bill accurately and/or quickly. For example, the person generating a bill may lack expert knowledge in the applicable field of medicine. As another example, the person generating a bill may lack expert knowledge in the billing coding standard (e.g., ICD-9 or ICD-10) that must be used to encode items in the bill.

For these and other reasons, what is needed are improved techniques for enabling users to generate bills quickly and accurately, while reducing the amount of expertise required by such users.

### SUMMARY

A computer system generates an initial set of billing codes based on one or more documents (e.g., a clinical note) representing a patient encounter, such as clinical notes created by a physician. The system expands the initial set of billing codes based on a billing code standard to create an expanded set of billing codes for consideration by the physician. The system provides output representing the expanded billing code set to the physician. The physician selects one or more billing codes from the expanded billing code set for inclusion in a final billing code set for use in a bill for the services provided in the patient encounter.

Other features and advantages of various aspects and embodiments of the present invention will become apparent from the following description and from the claims.

### BRIEF DESCRIPTION OF THE DRAWINGS

FIG. 1A is dataflow diagram of a system for retrieving patient data based on a clinical note according to one embodiment of the present invention;

FIG. 1B is a dataflow diagram of a system for generating a billing code set for consideration by a billing coder (e.g., a person who is entrusted with encoding a patient encounter) according to one embodiment of the present invention;

FIG. 1C is a dataflow diagram of a system for enabling a billing coder to select billing codes for inclusion in a bill according to one embodiment of the present invention;

FIG. 1D is a dataflow diagram of a system for adapting the billing code selection module of FIGS. 1A-1C according to one embodiment of the present invention;

FIG. 2A is a flowchart of a method for generating a billing code set for consideration by a billing coder according to one embodiment of the present invention;

FIG. 2B is a flowchart of a method for enabling a billing coder to select billing codes for inclusion in a bill according to one embodiment of the present invention;

FIG. 2C is a flowchart of a method for adapting the billing code selection module of FIGS. 1A-1C according to one embodiment of the present invention; and

FIG. 3 is an illustration of an example of a graphical representation of a billing code according to one embodiment of the present invention.

### DETAILED DESCRIPTION

Embodiments of the present invention assist physicians and others responsible for generating billing codes (referred to herein as “billing coders”) in the generation of billing codes for use in bills for healthcare services. The techniques disclosed herein, however, may be applied in fields other than healthcare (such as law, accounting, and consulting), and by billing coders other than physicians, such as nurses, transcriptionists, and billing coding specialists.

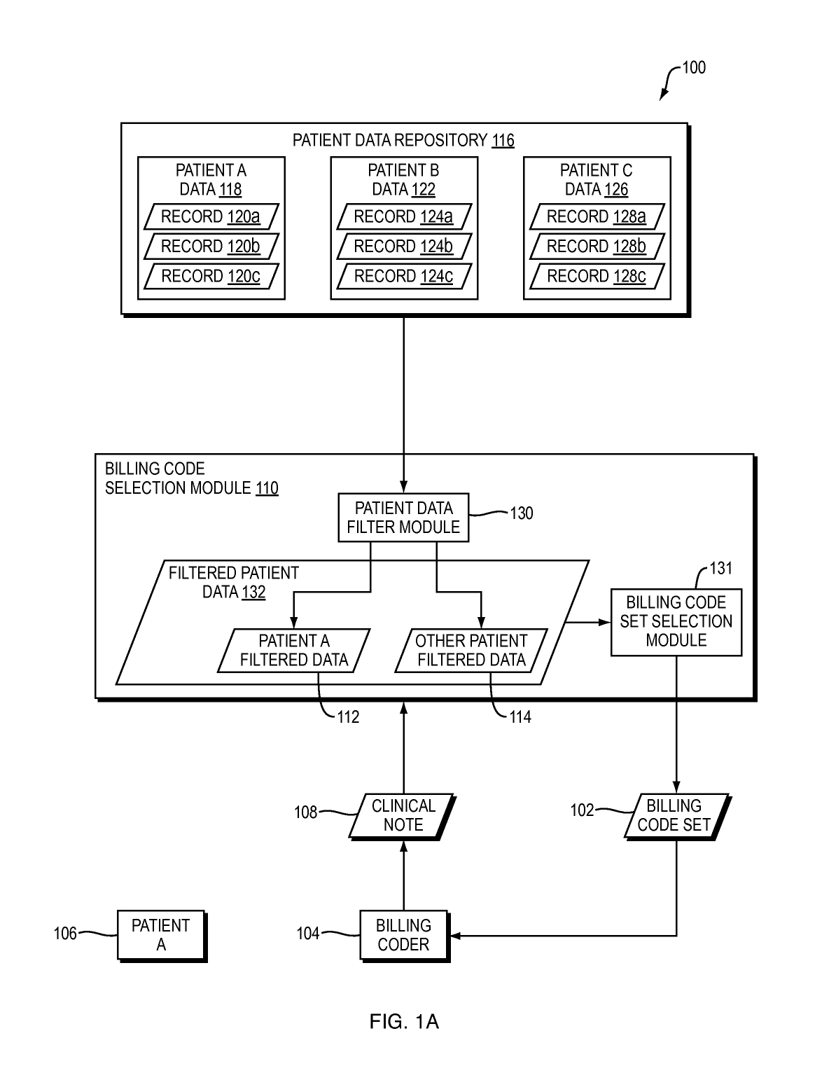

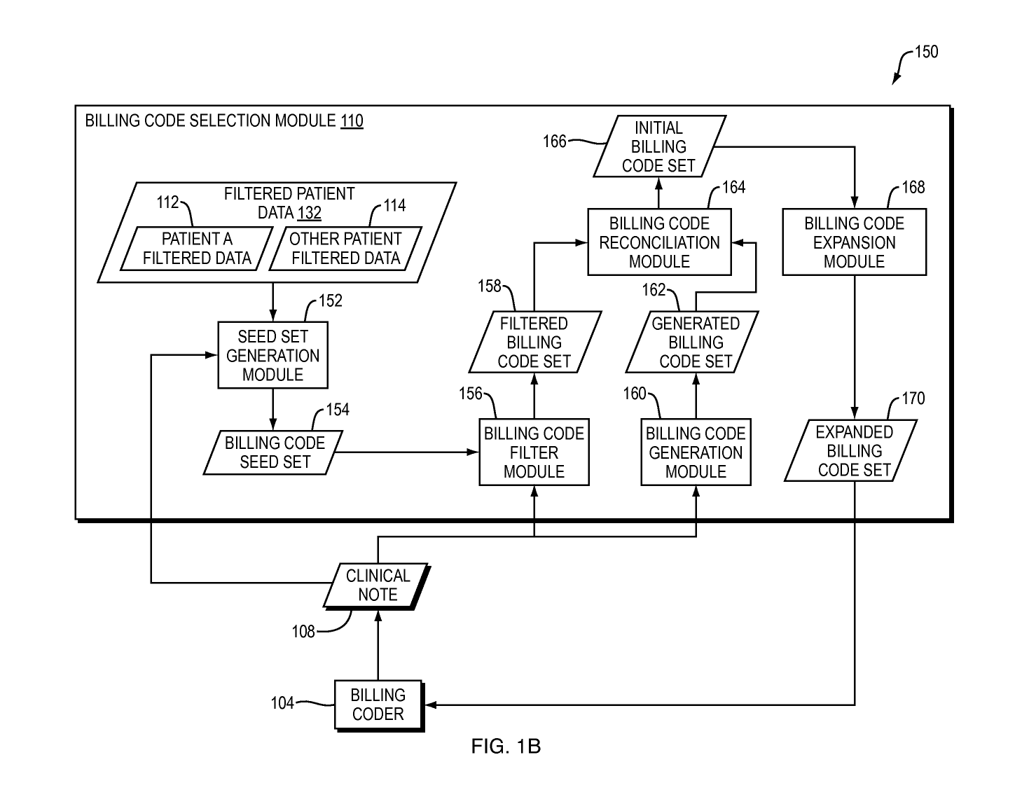

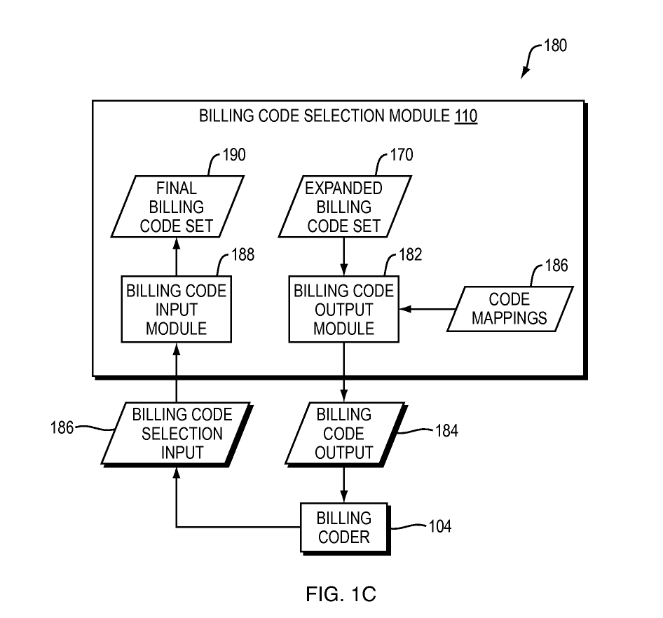

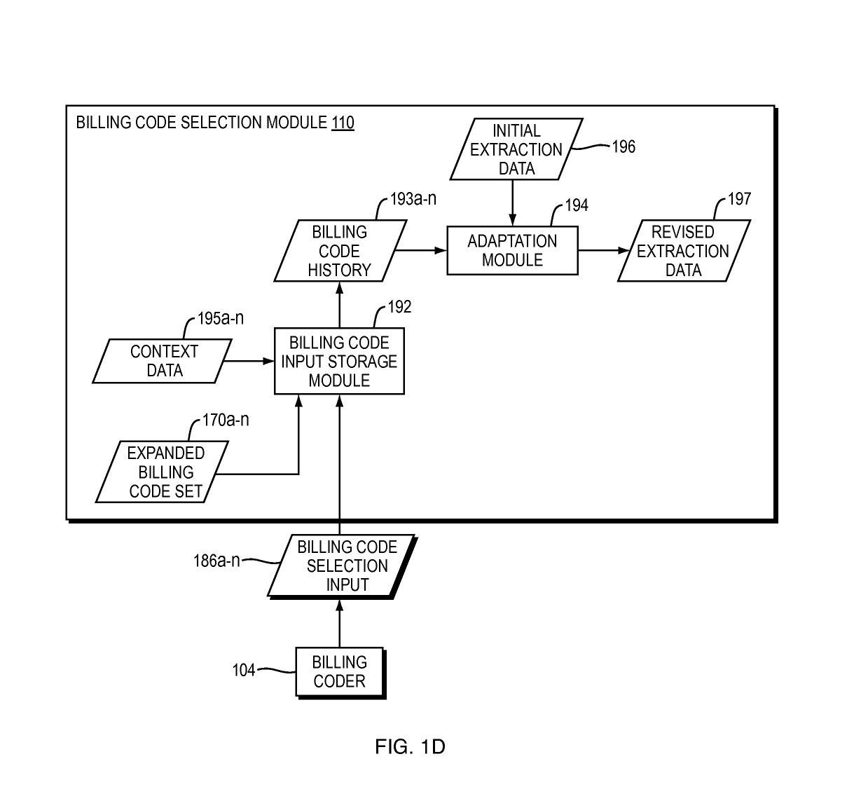

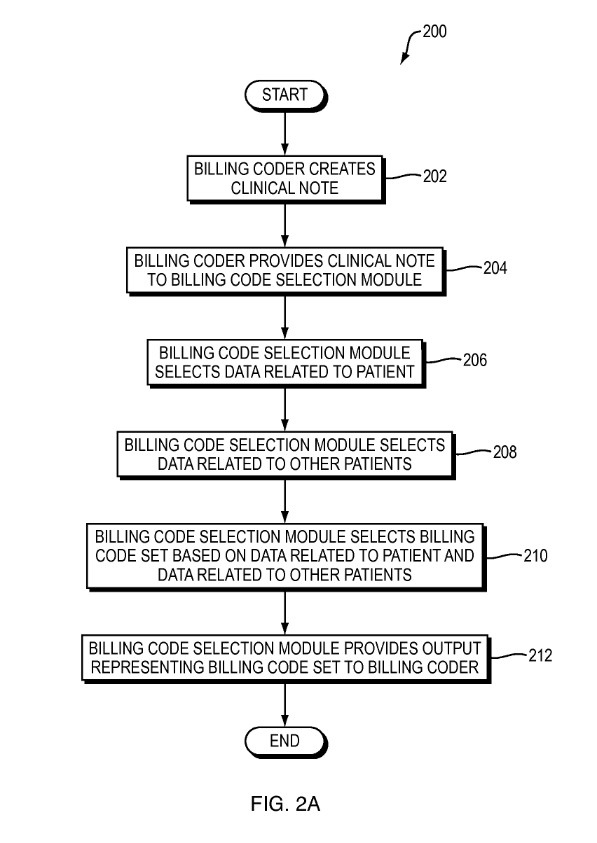

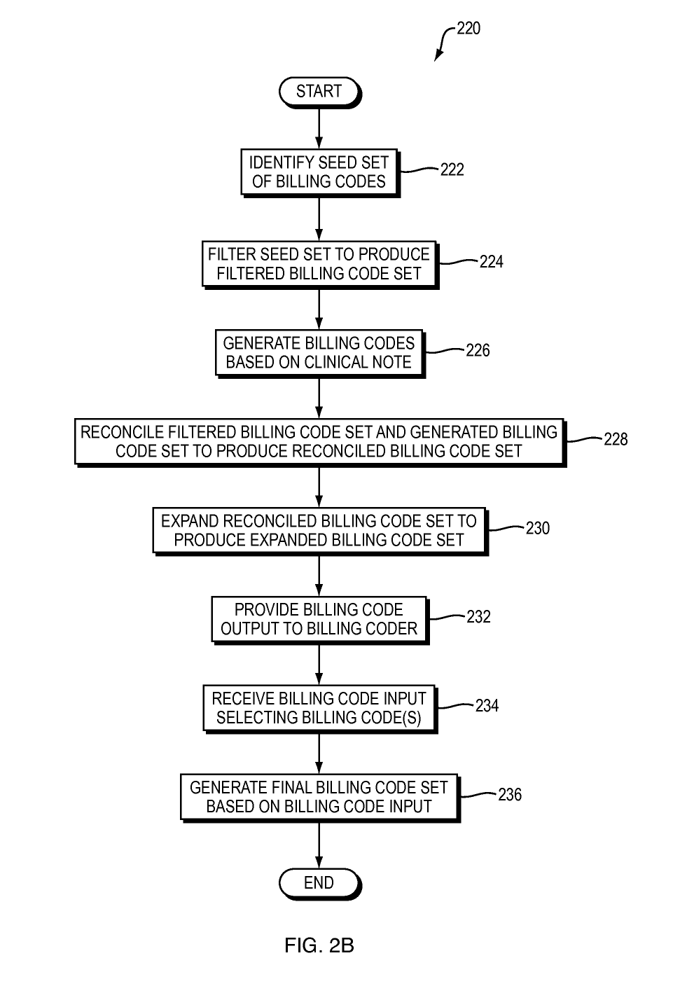

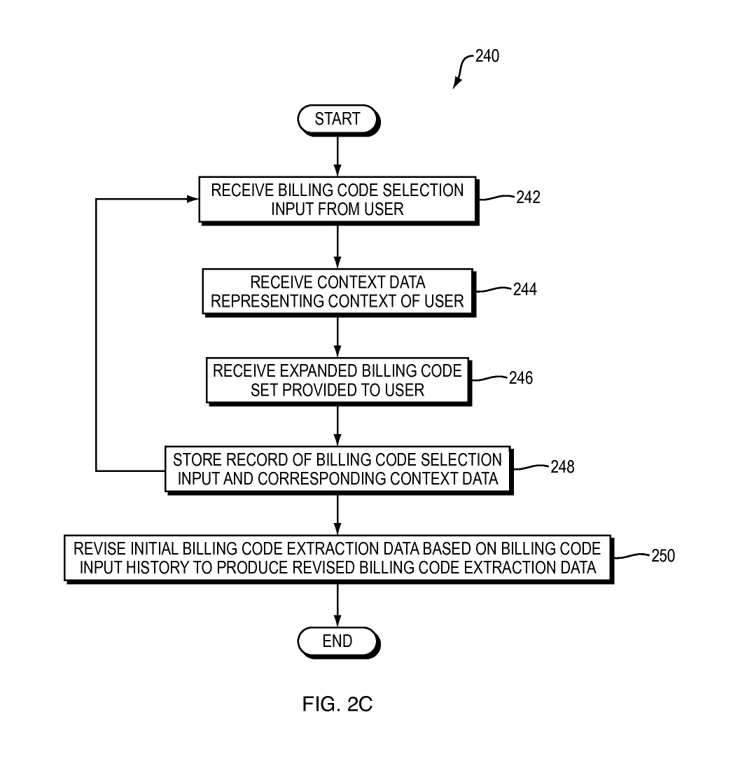

For example, referring to FIG. 1A, a dataflow diagram is shown of a system 100 for selecting a set of billing codes 102 and for providing the set of billing codes 102 to a billing coder 104 for consideration by the billing coder 104 for inclusion in a bill. Referring to FIG. 2A, a flowchart is shown of a first method 200 performed by the system 100 of FIG. 1A.

The billing coder 104 may be any human user of the system 100, such as a physician or billing coding specialist. For ease of explanation, the following description will refer to a particular example in which the billing coder 104 is a physician. It should be understood, however, that this is merely one example and does not constitute a limitation of the present invention. More specifically, the following description will refer to a particular example in which the physician 104, during or after an encounter with (e.g., examination of) a patient 106, a clinical note 108 describing the encounter. More generally, however, the system 100 of FIG. 1A may be applied to any situation in which the billing coder 104 generates codes based on one or more documents that are related to a billable service. The clinical note 108, therefore, may more generally be any document and/or other data. Furthermore, the patient 106 may be any person or other subject of the document 108.

In general, the physician 104 generates the clinical note 108 (FIG. 2, operation 202). The physician 104 may create the clinical note 108 in any of a variety of ways, and the clinical note 108 may take any of a variety of forms. For example, the physician 104 may create the clinical note 108 using any one or more of the following techniques:
the physician 104 may dictate a report to create a live and/or recorded audio signal representing the physician 104's speech, and the audio signal may then be transcribed (e.g., by a human transcriptionist, automatic speech recognition (ASR) engine, or a combination thereof) to generate the clinical note 108;
the physician 104 may create the clinical note 108 by typing or otherwise manually inputting contents of the clinical note 108 into a word processing document, spreadsheet, message (e.g., email message), electronic form, database record (e.g., an Electronic Health Record (EHR)), or any combination thereof;
the physician 104 may handwrite notes, which may be used by the physician 104 or other person to create the clinical note 108, such as in any of the ways described above;
the physician 104 may copy existing data into and/or attach existing data to the clinical note 108 to create and/or supplement the clinical note 108, where such existing data may, for example, be obtained from any of the sources listed above.

The system 100 also includes a billing code selection module 110. In general, and as will be described in more detail below, the billing code selection module 110 selects a set of billing codes 102 for consideration by the physician 104, and provides those billing codes 102 as output to the physician 104.

The physician 104 provides the clinical note 108 to the billing code selection module 110 (FIG. 2, operation 204). The physician 104 may provide the clinical note 108 to the billing code selection module 110 in any of a variety of ways. For example, the physician 104 may provide input (such as a “send” command) to instruct the system 100 to provide clinical note 108 to the billing code selection module 110. Alternatively, for example, the system 100 may provide the clinical note 108 to the billing code selection module 110 without requiring any command from the physician 104 to do so. For example, the system 100 may automatically provide the clinical note 108 to the billing code selection module 110 upon completion of the clinical note 108 by the physician 104. As another example, the system 100 may continuously (e.g., periodically) monitor the clinical note 108 as it is being created by the physician 104 and provide updated versions of the clinical note 108 to the billing code selection module 110 while the clinical note is being created by the physician 104.

The billing code selection module 110 receives the clinical note 108 and identifies data 112 related to the patient 106 (FIG. 2A, operation 206). The billing code selection module 110 may, for example, identify the patient-related data 112 based on data identifying the patient 106, such as any one or more of the following: data within the clinical note 108, data derived from the clinical note 108, and data other than the clinical note 108. For example, the clinical note 108 may include a name or other identifier of the patient 106, which the billing code selection module 110 may use to identify the patient-related data 112. The billing code selection module 110 may identify the patient identifier in the clinical note 108 in any of a variety of ways, such as by applying techniques disclosed in U.S. Pat. No. 7,584,103 B2, issued on Sep. 1, 2009, entitled, “Automated Extraction of Semantic Content and Generation of a Structured Document From Speech”; and/or U.S. Pat. No. 7,716,040 B2, issued on May 11, 2010, entitled, “Verification of Extracted Data,” both of which are hereby incorporated by reference herein. As yet another example, the physician 104 may provide separate input (not shown) which specifies the patient identifier.

The billing code selection module 110 may use any such patient identifier to obtain data related to the patient 106 from a patient data repository 116. The repository 116 may include any one or more of the following: electronic health records (EHRs) of the patient 106 and of other patients, clinical notes related to the patient 106 and to other patients, other documents (such as unstructured and/or structured documents) related to the patient 106 and to other patients, bills related to the patient 106 and other patients, and any other data (such as documents and/or database records) related to the patient 106 and other patients. Documents and other data stored in the repository 116 may include structured documents of the kind produced using the techniques disclosed in the above-referenced U.S. Pat. Nos. 7,584,103 and 7,716,040, and may therefore include encoded concepts. Although the patient data repository 116 is shown in FIG. 1A as a single data store for ease of illustration, in practice the patient data repository 116 may be implemented as multiple data stores which may be distributed in any manner.

For purposes of example, the patient data repository 116 is shown in FIG. 1A as containing:
data 118 relating to patient 106, including records 120a, 120b, and 120c;
data 122 relating to a first patient (not shown) other than patient 106, including records 124a, 124b, and 124c; and
data 126 relating to a second patient (not shown) other than patient 106, including records 128a, 128b, and 128c.

The particular numbers of patient data records 120a-c, 124a-c, and 128a-c shown in FIG. 1A are merely examples and do not constitute limitations of the present invention. Each of the data records 120a-c, 124a-c, and 128a-c may be of any of the types disclosed herein (e.g., EHR, clinical note) in any combination.

As mentioned above, the billing code selection module 110 may identify an identifier of the patient 106. The billing code selection module 110 may use this identifier to identify data 118 related to the patient 106, such as by using the identifier to query the repository 116 or as an index into the repository 116. The billing code module 110 may add some or all of the clinical note 108 to the patient 106's data 118 in the repository 116, such as by adding a copy of and/or reference to some or all of the clinical note 108 to the patient 106's data 118.

The billing code selection module 110 may include a patient data filter module 130. In general, the patient data filter module 130 may retrieve data from the repository 116 and, optionally, filter and/or otherwise process such data. For example, the filter module 130 may retrieve some or all of the data 118 related to patient 106 from the repository 116, and store such data as filtered data 112.

The filter module 130 may also retrieve some or all of the data 122 and 126 related to other patients in the repository 116. In particular, the filter module 130 may retrieve, from the repository 116, data related to patients other than patient 106, where the retrieved data satisfies a relevance criterion associated with patient 106 (FIG. 2A, operation 208). The filter module 130 may store such data as filtered data 114. The combination of the retrieved data 112 for patient 106 and the retrieved data 114 for other patients is referred to herein as filtered patient data 132.

The filter module 130 may use any of a variety of relevance criteria to retrieve the filtered data 114. For example, the relevance criterion may select some or all of the patient data associated with patients having patient data which represents one or more of the following:
similar problems to problems being experienced by the patient 106;
similar medications to medications being taken by the patient 106;
similar procedures to procedures that have been performed on the patient 106.

The filter module 130 may determine whether patient data associated with patients other than patient 106 satisfies the relevance criterion by, for example, comparing the patient data of the other patients to any one or more of the following: the relevance criterion, data in the patient 106's data 118, and data in the clinical note 108. For example, the filter module 130 may determine whether the patient associated with patient data 122 is taking similar medications to patient 106 by comparing the current medications list in patient data 122 with the current medications list in patient data 118 and/or current medications data in the clinical note 108.

As mentioned above, the filter module 130 may retrieve some or all of patient 106's data 118. If the filter module 130 retrieves less than all of the patient 106's data 118, the filter module 130 may select a subset of the patient 106's data in any of a variety of ways. For example, the filter module 130 may retrieve only data from the patient 106's data that is associated with the same encounter (e.g., hospital stay, procedure, or appointment) as the clinical note 108. Even if the filter module 130 retrieves only a subset of the patient 106's data 118, the filter module 130 may also retrieve certain summary elements from the patient 106's data, such as any one or more of the following: the patient 106's problem list (which may describe current and/or past medical problems and/or complaints of the patient 106), current medications list (which may describe medications currently prescribed to the patient 106), past medications list (which may describe medications previously but no longer prescribed to the patient 106), and procedures list (which may described procedures previously performed and/or scheduled to be performed on the patient 106). The filter module 130 may compare data 122 and 126 associated with other patients to determine whether to retrieve individual elements of such data, e.g., by retrieving only the elements of other patient data 122 and 126 that are sufficiently similar to the retrieved data 112 of the patient 106 according to some measure of similarity (e.g., the relevance criterion described above). In particular, the filter module 130 may retrieve data associated with encounters of other patients that are sufficiently similar to the current encounter of patient 106 (i.e., the encounter associated with clinical note 108).

In general, once the billing code module 110 has retrieved the data 112 associated with patient 106 and the data 114 associated with one or more other patients, a billing code selection module 131 in the billing code module 110 may use such data 112 and 114 to select the billing code set 102 (FIG. 2A, operation 210) and then provide output representing the billing code set 102 to the physician 104 (FIG. 2A, operation 212).

The billing code selection module 110 may select the billing codes 102 in any of a variety of ways. Referring to FIG. 1B, a dataflow diagram is shown of a system 150 for selecting the billing code set 102 according to one embodiment of the present invention. Referring to FIG. 2B, a flowchart is shown of a method 220 performed by the system 150 according to one embodiment of the present invention.

The billing code selection module 110 may include a seed set generation module 152, which generates a seed set 154 of billing codes (FIG. 2B, operation 222). Note that the generation of the seed set 154 is optional. The seed set generation module 152 may generate the seed set 154 in any of a variety of ways. For example, the seed set generation module 152 may generate the seed set 154 based on the clinical note 108, such as data (e.g., encoded concepts) in the clinical note 108 representing one or more of the following: diseases of the patient 106 (e.g., current and/or past diseases), problems of the patient 106 (e.g., current and/or past problems), and procedures that have been performed on the patient 106 (e.g., procedures performed on the patient during the encounter that is the subject of the clinical note 108 and/or past encounters). Additionally or alternatively, the seed set generation module 152 may generate the seed set 154 based on some or all of the filtered patient data 132. Recall that the filtered patient data 132 may include billing codes, such as billing codes within existing bills and/or billing codes associated with clinical notes and other data within the filtered data 132. The seed set generation module 152 may generate the seed set 154 based on such billing codes. The seed set 154 may, for example, include some or all of such billing codes. As a particular example, the seed set 154 may include billing codes from the filtered patient data 132 which are associated with data (e.g., clinical notes) that are similar to the clinical note 108 provided by the physician 104.

The billing code selection module 110 may include a billing code filter module 156, which may filter the billing code seed set 154 (i.e., remove one or more billing codes from the billing code seed set 154) to produce a filtered billing code set 158 (FIG. 2B, operation 224). The billing code filter module 156 may produce the filtered billing code set 158 in any of a variety of ways. For example, recall that the clinical note 108 may include, or be processed to include or otherwise be associated with, encoded concepts. The billing codes in the seed set 154 may also be associated with encoded concepts. The billing code seed set 154 may include data representing such encoded concepts. The billing code filter module 156 may compare the concepts encoded in the clinical note 108 with the concepts associated with the billing codes in the billing code seed set 154 to produce the filtered billing code set 158, by removing from the seed set 154 any billing codes which are not associated with any concept associated with the clinical note 108.

The billing code selection module 110 may include a billing code generation module 160, which may generate a set 162 of billing codes based on the concepts in or otherwise associated with the clinical note 108 (FIG. 2B, operation 226). The billing code generation module 160 may produce the generated billing code set 162 in any of a variety of ways. For example, recall that the clinical note 108 may include, or be processed to include or otherwise be associated with, encoded concepts. The billing code generation module 160 may map each concept in the clinical note 108 to a corresponding billing code within a particular billing code standard, such as ICD-9 or ICD-10. The billing code generation module 160 may, for example, be preconfigured with a predetermined set of mappings between concept codes and billing codes, and use such a predetermined set of mappings to generate the generated billing code set 162.

The billing code selection module 110 may include a billing code reconciliation module 164, which may receive as input the filtered billing code set 158 and the generated billing code set 162, and reconcile the two to produce an initial billing code set 166 (FIG. 2B, operation 228). The billing code reconciliation module 164 may produce the initial billing code set 166 in any of a variety of ways. For example, the billing code reconciliation module 164 may compare the billing codes in the filtered billing code set 158 to the billing codes in the generated billing code set 162, and include in the initial billing code set 166 only those billing codes that are in both the filtered billing code set 158 and the generated billing code set 162.

Recall that the seed set 154 is optional. If the seed set 154 is not used, then the billing code filter module 156, the filtered billing code set 158, and the billing code reconciliation module 164 may be omitted, and the generated billing code set 162 may be used to perform the functions disclosed herein for the initial billing code set 166.

The billing code selection module 110 may include a billing code expansion module 168, which may receive as input the initial billing code set 166 and produce an expanded billing code set 170 as output (FIG. 2B, operation 230). The billing code expansion module 158 may produce the expanded billing code set 170 in any of a variety of ways. For example, the billing code expansion module 168 may include, or otherwise receive as input, data representing the structure (e.g., hierarchical structure) of a billing code standard according to which the billing codes in the set 166 are defined. Examples of such standards include ICD-9, ICD-10, and CPT. For each billing code C in the initial billing code set 166, the billing code expansion module 168 may:
identify, based on the billing code standard, one or more billing codes that are related to billing code C, such as billing codes that are ancestors (e.g., parents), descendants (e.g., children), siblings, and/or cousins of billing code C in the hierarchy of the billing code standard; and
add the identified billing code(s) to the initial billing code set 166 to produce the expanded billing code set 170.

As one particular example, consider the billing code M17 in the ICD-10 code. This billing code represents Osteoarthritis of the knee. Descendants of this billing code in ICD-10 include the following billing codes:
M1710: Unilateral primary osteoarthritis, unspecified knee
M1711: Unilateral primary osteoarthritis, right knee
M170: Bilateral primary osteoarthritis of knee
M175: Other unilateral secondary osteoarthritis of knee
M1712: Unilateral primary osteoarthritis, left knee
M179: Osteoarthritis of knee, unspecified
M172: Bilateral post-traumatic osteoarthritis of knee
M1731: Unilateral post-traumatic osteoarthritis, right knee
M1730: Unilateral post-traumatic osteoarthritis, unspecified knee
M174: Other bilateral secondary osteoarthritis of knee
M1732: Unilateral post-traumatic osteoarthritis, left knee

If the initial billing code set 166 includes the ICD-10 code M17, then the billing code expansion module 168 may identify, and add to the initial billing code set 166, some or all of the related billing codes listed above, as a result of which both the original billing code M17 and the related billing codes listed above will appear within the expanded billing code set 170.

The expanded billing code set 170 is generated with the intent of producing a set of proposed billing codes that is comprehensive and therefore extremely unlikely to omit any applicable billing code. Embodiments of the present invention generate such a comprehensive set of billing codes to eliminate the need for the billing coder 104 to look outside the expanded billing code set 170 for applicable billing codes. In other words, one benefit of making the expanded billing code set 170 comprehensive is that it presents the billing coder 104 with a set of billing codes 104 from which the final set of billing codes for inclusion in the bill can be confidently selected. Eliminating the need for the billing coder 104 to look outside the expanded billing code set 170 for billing codes to include in the final bill is a feature of embodiments of the present invention that both increases the speed with which the final bill may be generated and increased the accuracy of that bill.

Another benefit of making the set of proposed billing codes comprehensive is that presenting the billing coder 104, such as a physician, with such a comprehensive set of billing codes increases the likelihood that reviewing such a set of billing codes will prompt the physician to remember any additional billable services that the physician provided to the patient 106, but which the physician forgot to document. In response to reviewing the comprehensive set of billing codes, the physician may recall a billable service that was performed, including one or more billing codes for such a service on the bill, and possibly modify the clinical note 108 to include documentation of the forgotten service. This may result in an improvement both to the quality of documentation of the patient encounter and the quality of reimbursement for services performed by the physician.

The billing code selection module 110 may provide output representing the expanded billing code set 170 to the billing coder 104. For example, referring to FIG. 1C, a dataflow diagram is shown of a system 180 for providing such output to the billing coder 104 and for receiving a selection of billing codes from the billing coder 104.

The billing code selection module 110 may include a billing code output module 182, which may produce output 184 representing some or all of the expanded billing code set 170, and provide such output 184 to the physician 104 (FIG. 2B, operation 232). The billing code output 184 may take any of a variety of forms. For example, the billing code output 184 may take the form of a list representing the expanded billing code set 170. The billing code output module 182 may display such a list on a screen, read such a list aloud, or display a graphical version of the expanded billing code set 170 that concisely summarizes the information in the expanded billing code set 170. Each billing code in the expanded billing code set 170 may be represented in the output 184 using a representation of the code which is intended to be easier for the user 104 to understand than the billing code itself, particularly if the user 104 is not trained to understand the billing code standard (e.g., ICD-9, ICD-10, or CPT) that has been used to encode the billing code. The billing code output module 182 may derive such human-readable versions from the billing codes in the expanded billing code set 170 for use in the billing code output 184 in any of a variety of ways. For example, the billing code selection module 110 may include a set of code mappings 186, which map billing codes (such as billing codes defined according to a billing code standard) to clinically-relevant text (and/or other content) corresponding to those billing codes. The billing code output module 182 may, as part of generating the billing code output 184 based on the expanded billing code set 170, use the code mappings 186 to map codes in the expanded billing code set 170 to clinically-relevant representations of those codes in the billing code output 184. The clinically-relevant representations of codes may include text, graphics, and/or other content which is not defined according to the billing code standard in which the expanded billing code set 170 is encoded.

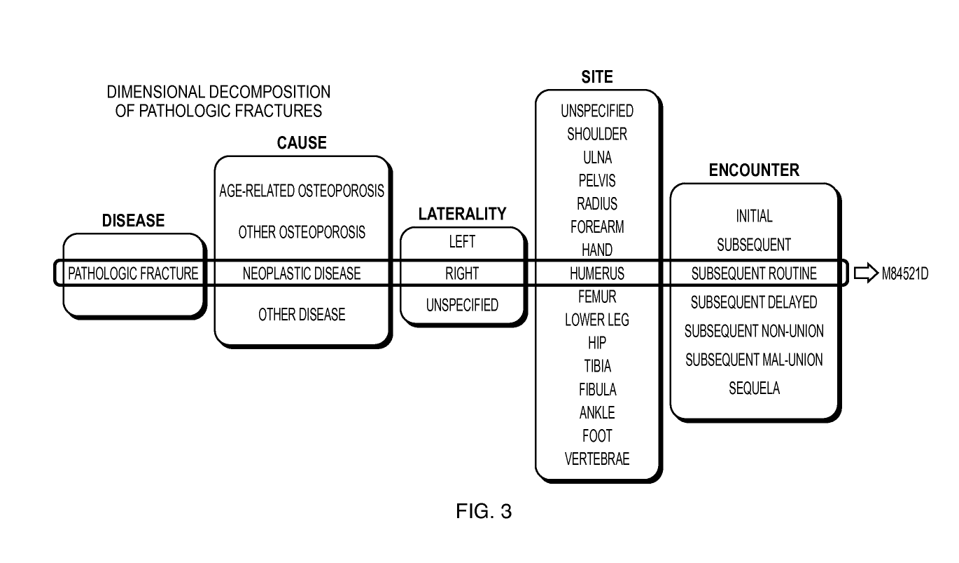

The clinically-relevant representations of the billing codes in the billing code output 184 may be simplified, in comparison to the corresponding billing codes in the expanded billing code set 170, in any of a variety of ways. For example:
The clinically-relevant representation of a billing code may include text and/or other content which is not included in the billing code itself. Consider, for example, the ICD-10 code M84521D. This code represents a pathological fracture in neoplastic disease, right humerus, subsequent encounter for fracture with routine healing. Instead of presenting this description to the user 104, the billing code output module 182 may visually decompose the construction of the billing code to simplify it for the comprehension of the user 104. This particular code captures five dimensions related to the patient: (1) the type of disease, in this case, pathologic fracture; (2) the causal factor, in this case neoplastic (cancer) related, as opposed to say age-related osteoporosis; (3) laterality, in this case the right side; (4) the specific site of manifestation of the disease, in this case the humerus; and (5) the type of encounter with the patient, in this case the encounter is a subsequent (i.e., not the first) visit from the patient and the patient has been responding to treatment as expected. The billing code output 184 may present all of this information in a graphical form (such as that shown in FIG. 3) that intended to reduce the cognitive load on the user 104 when attempting to understand what the billing code M84521D means. The other example, shown earlier, osteoarthritis of the knee, can also be broken down in a similar fashion.
The clinically-relevant representation of a billing code may omit text and/or other content from the billing code itself. The example immediately above illustrates this point.

Regardless of the particular techniques that are used to generate the billing code output 184 based on the expanded billing code set 170, the billing code output 184 may include descriptions of clinical conditions, either instead of or in addition to the billing codes 170 themselves. Such descriptions may include text and/or other content which is not defined according to the billing code standard in which the expanded billing code set 170 is encoded. Such output 184 is intended to be presented in a format that is understandable to a person who is not an expert in the billing code system in which the billing code set 170 is encoded, and to present information about the billing code set 170 that is clinically relevant and understandable to the user 104.

A list representing the expanded billing code set 170 may, for example, be displayed hierarchically according to the hierarchy of the billing code standard that defines the billing codes in the billing code set 170. For example, if a first billing code in the set 170 is a descendant of a second billing code in the set 170, then the visual representation of the first billing code may be displayed in a manner that is superior to (e.g., above or to the left of) the visual representation of the second billing code. In this way, the billing code output 184 may display the billing code set 170 in a visual hierarchical structure that corresponds to the hierarchical relationships of the billing codes in the billing code set 170 within the defining billing code standard. Such a visual hierarchical structure may, for example, be collapsible and expandable so that the physician 104 may provide input that causes the billing code selection module 110 to modify the billing code output 184 to collapse or expand branches of the hierarchical structured based on the physician's input. Other alternative ways of visually representing the code selection include, for example, breaking the code selection process along dimensional lines, as suggested in the example earlier with respect to billing code M84521D.

The billing code selection module 110 may include a billing code input module 118. The physician 104 may provide, to the billing code input module 188, billing code selection input 186 which specifies one or more of the billing codes in the expanded billing code set 170. The billing code input module 188 may receive the input 118 (FIG. 2B, operation 234) and, in response, may generate a final billing code set 190 containing (e.g., consisting solely of) the billing code(s) specified by the billing code selection input 186 (FIG. 2B, operation 236). The final billing code set 190 may be encoded according to a billing code standard, such as any version of ICD-9, ICD-10, or CPT. The final billing code set 190 may be encoded according to the same billing code standard as the expanded billing code set 170.

The physician 104 may provide the billing code selection input 186 in any of a variety of ways. For example, the physician 104 may click on, tap, or otherwise select one or more visual representations of billing codes in the billing code output 184 to select the billing codes represented by such representations in the expanded billing code set 170. This is merely one example of a way in which the physician 104 may provide the billing code selection input 186 by providing input that references representations of billing codes in the billing code output 184.

As described above, the representations of the billing codes in the billing code output 184 may take the form of clinically-relevant text, graphics and/or other content, such as described above in connection with the pathologic fracture example presented earlier. If the user 104 provides the billing code selection input 186 by providing input in association with such clinically-relevant content, such as by selecting the clinically-relevant content (e.g., the graphical selection of the applicable dimensions that aids in the convergence to a specific code) and/or providing an instruction in association with the clinically-relevant content (e.g., if the base disease—pathologic fracture—is not applicable to this patient, the clinician may issue an instruction to reject the entire structure associated with it), then the billing code input module 188 may identify the corresponding billing code in the expanded billing code set 170 and take an action consistent with the input 186 in connection with that billing code to generate or update the final billing code set. For example:
The billing code input module 188 may remove, from the expanded billing code set 170, the billing code corresponding to presentation of pathologic fracture as a possible diagnosis for the patient in response to receiving a “reject” instruction from the user 104 in connection with the diagnosis of pathologic fracture in the billing code output 184. In this case, the final billing code set 190 would not include the billing code representing insertion of a stent into the patient.
The billing code input module 188 may retain (i.e., not remove), the billing code corresponding to pathologic fracture in the expanded billing code set 170 in response to receive an “approve” instruction from the user 104 in connection with the presentation of the diagnosis pathologic fracture in the billing code output 184 (e.g., the presentation shown in FIG. 3). In this case, the final billing code set 190 would include the billing code representing the diagnosis of pathologic fracture for the patient.

When taking action in response to the billing code selection input 186 to generate the final billing code set 190, the billing code input module 188 may identify the billing code(s), in the expanded billing code set 170, to which the user 104's selection input refers in a variety of ways. For example, when generating the billing code output 184 based on the expanded billing code set 170, the billing code output 182 module may generate and store (e.g., in the billing code output 184) mappings between each of the codes in the expanded billing code set 170 and the corresponding representation of that code in the billing code output 184. For example, when generating the related code sets for pathologic fracture in the billing code output 184 based on a code in the expanded billing code set 170 representing the diagnosis of pathologic fracture for the patient, the billing code output module 182 may generate and store data representing a mapping between the text in the output 184 and the corresponding code in the expanded billing code set 170. As a result, when the user 104 provides input 186 representing an instruction which references a portion of the billing code output 184 (such as the diagnosis of pathologic fracture), the billing code selection input 186 may use the previously-stored mappings between text and codes to identify the code, in the expanded billing code set 170, that corresponds to the text referenced by the user 104's input 186. The billing code input module 188 may then perform an appropriate action on the identified code based on the user 104's input 186, such as removing the identified code from the final billing code set 190 or retaining the identified code in the final billing code set 190.

The billing code input module 188 may generate the final billing code set 190 in any of a variety of ways. For example, the billing code input module 188 may include, in the final billing code set 190, those billing codes, and only those billing codes, specified by the billing code selection input 186.

Although not shown in FIG. 1, the billing code selection module 110 may provide the final billing code set 190 as output, such as by providing such output to the physician 104, by including such output in a bill represented and stored according to any billing code format, and/or by storing such output in patient 106's data 118 in the patient data repository 116, thereby making the billing code set 190 available for subsequent use.

Although certain embodiments described above are described as using preconfigured rules or other preconfigured steps to generate the expanded billing code set 170 that is presented to the user 104, this is merely an example and does not constitute a limitation of the present invention. Embodiments of the present invention are not limited to using a fixed set of techniques to generate billing codes to present to users, but instead may adapt the techniques used to generate billing codes in response to behavior of the user 104 (and of other users) over time.

For example, referring to FIG. 1D, a dataflow diagram is shown of a system for adapting the billing code selection module 110 over time in response to behavior of the user 104 and of other users. Referring to FIG. 2C, a flowchart is shown of a method 240 performed by the system of FIG. 1D according to one embodiment of the present invention.

As described above, the billing code selection module 110 may use any of a variety of techniques to generate the billing code set 170 that is presented to the user 104 for review. For example, the billing code selection module 110 may use a set of rules to generate the expanded billing code set 170. The term “billing code extraction data” will be used herein to refer to the data (e.g., rules) that the billing code selection module 110 uses to generate the expanded billing code set 170. As shown in FIG. 1D, the billing code selection module 110 may include an initial set of such billing code extraction data 196, which the billing code selection module 110 may use initially to perform the functions described above. In general, the system of FIG. 1D and the method 240 of FIG. 2C may be used to revise the initial billing code extraction data 196 based on one or more billing code inputs 186a-n received from the user 104 (and possibly from other users) and the contexts 195a-n in which such inputs 186a-n were received, to generated revised billing code extraction data 197. The billing code selection module 110 may then apply the techniques of FIGS. 1A-1C and FIGS. 2A-2B to the revised billing code extraction data 197.

More specifically, the billing code selection module 110 may obtain a first billing code selection input 186a from the user 104, in any of the ways disclosed above (FIG. 2C, operation 242).

The billing code selection module 110 may also receive context data 195a representing a current context of the user 104 (e.g., a context of the user 104 at the time when the user 104 provides the billing code selection input 186a) (FIG. 2C, operation 244). The context data 195a may include any data representing a context of the user 104, such as data representing the user 104's identity (e.g., real name or username) and/or role (e.g., physician, nurse, billing coder), medical specialty (e.g., internal medicine, pediatrics, or cardiology), the organization (e.g., hospital, department) in which the user 104 works, and the current date and/or time of day.

The billing code selection module 110 may also receive the expanded billing code set 170a that was provided to the user 104 within the context represented by the context data 195a (FIG. 2, operation 246).

The billing code input storage module 192 stores a record of the billing code selection input 186a, the corresponding context data 195a, and the corresponding expanded billing code set 170a as a billing code input history record 193a (FIG. 2C, operation 248).

Operations 242-248 of FIG. 2C may be repeated any number of times to store any number of records 193a-n of billing code selection inputs 186a-n and corresponding context data 195a-n and expanded billing codes sets 170a-n from the user 104 (and possibly from other users). The billing code input history records 193a-n may include discrete records of the individual billing code selection inputs 186a-n and corresponding context data 195a-n and expanded billing code sets 170a-n. Additionally, or alternatively, the billing code input storage module 192 may derive data from the billing code selection inputs 186a-n, context data 195a-n, and expanded billing code sets 170a-n, and store such derived data, such as aggregate data and other statistics, in the billing code input history records 193a-n.

The system of FIG. 1D may also include an adaptation module 194, which may adapt the initial billing code extraction data 196 based on the billing code input history 193a-n to produce revised billing code extraction data 197 (FIG. 2C, operation 250). The revised billing code extraction data 197 may take any of a variety of forms, such as a set of revised rules which differ from the initial rules represented by the initial billing code extraction data 196, a revised neural network which differs from an initial neural network represented by the initial billing code extraction data 196, or a revised set of statistical classifiers which differ from an initial set of statistical classifiers represented by the initial extraction data 196. The adaptation module 194 may generate the revised billing code extraction using any of a variety of techniques to generated the revised billing code extraction data 197, such as any technique based on machine learning, neural networks, or statistical classifiers.

For example, if the billing code history 193a-n indicates that the user 104 (and possibly other users) tends to accept a particular billing code in the expanded billing code sets 170a-n in a particular context (or a particular set of related contexts), then the adaptation module 194 may revise the initial extraction data 196 to indicate, in the revised extraction data 197, that the accepted billing code should continue to be presented to the user 104 (and possibly other users) in expanded billing code sets 170 in the same and similar contexts in the future, and possibly that the accepted billing code should be emphasized such users 104, such as by displaying it in bold or displaying it higher in a list than previously.

As another example, if the billing code history 193a-n indicates that the user 104 (and possibly other users) tends to reject a particular billing code in the expanded billing code sets 170a-n in a particular context (or a particular set of related contexts), then the adaptation module 194 may revise the initial extraction data 196 to indicate, in the revised extraction data 197, that the rejected billing code should not be presented to the user 104 (and possibly other users) in expanded billing code sets 170 in the same and similar contexts in the future.

Regardless of the particular manner in which the adaptation module 194 adapts the initial extraction data 196 to produce the revised extraction data 197, once the revised extraction data have been produced, the billing code selection module 110 may apply the revised extraction data 197 to the techniques disclosed herein in connection with FIGS. 1A-1C and FIGS. 2A-2B to generate future expanded billing code sets in accordance with the revised extraction data 197 and to provide output representing such expanded billing code sets to the user 104 (and possibly to other users). Furthermore, the method 240 of FIG. 2C may be performed any number of times to further revise the revised extraction data 197 any number of times based on new billing code selection inputs, context data, and expanded billing code sets once they have been generated.

More generally, any of the methods of FIGS. 2A-2C may be performed any number of times. For example, the methods of FIGS. 2A-2B may be repeated in response to generation of new clinical notes. Furthermore, recall that the system 100 may continuously (e.g., periodically) monitor the clinical note 108 as it is being created by the physician 104 and provide updated versions of the clinical note 108 to the billing code selection module 110 while the clinical note is being created by the physician 104. In such a case, any one or more of the methods of FIGS. 2A-2C may be repeated each time the clinical note is updated. This enables embodiments of the present invention to optimize both the clinical note 108 and the set of accompanying billing codes for maximum consistency.

Embodiments of the present invention have a variety of advantages, such as the following. As the healthcare industry adopts increasingly complex billing coding schemes, such as ICD-10, it is becoming increasingly important to provide assistance to physicians and other billing coders in the process of generating billing codes based on services rendered. Embodiments of the present invention may be used to assist billing coders in selecting appropriate billing codes for inclusion in bills by providing such billing codes with a set of potentially relevant billings codes for inclusion in bills. Such proposed billing codes may be based on data related to the patient encounter for which the bill is being generated, such as any one or more of the following: a clinical note created by the physician, data (such as data in EHRs) related to the patient who is the subject of the clinical note, and data (such as data in EHRs) related to other patients who are similar to the patient who is the subject of the clinical note. As a result, the proposed billing codes that are presented to the billing coder are designed to be relevant to the encounter and therefore likely to be useful for inclusion in the bill.

Such techniques reduce the cognitive burden on the billing coder by providing the billing coder with a relatively small set of proposed billing codes from which to select, compared to the very large set of billing codes in a system such as ICD-10. As a result, physicians may use the techniques disclosed herein to select billing codes more easily than if they had to consult the entire set of ICD-10 codes, especially because physicians may not be familiar with the details of the ICD-10 code specification. Similarly, embodiments of the present invention may benefit billing coders who are expert in billing coding systems (such as ICD-10) but who are not medical experts by providing such billing coders with a set of billing codes that are relevant to the healthcare services provided by the physician to the patient, and which the billing coder might not otherwise have been able to identify easily due to a lack of specialized medical knowledge.

Furthermore, because embodiments of the present invention may be used to generate a customized set of proposed billing codes each time a clinical note is generated, the proposed billing codes generated by embodiments of the present invention may be dynamically generated and tailored to the current patient encounter and the physician's field of practice. In the current state of the art it is known for physicians to use printed forms, known as “superbills,” which contain a list of billing codes that are tailored to a specific medical practice, such as cardiology, orthopedics, and internal medicine. Embodiments of the present invention may be used to generate the electronic equivalents of such superbills, but to do so in a way that is tailored dynamically to the current patient encounter, not merely to the physician's field of practice, based on a variety of data such as the clinical note 108 and the filtered patient data 132. As a result, the proposed billing codes 170 generated by embodiments of the present invention are more likely to contain billing codes that are relevant to the current patient encounter than traditional superbills, and are less likely to omit billing codes that are relevant to the current patient encounter than traditional superbills.

Similarly, if individual codes within a billing code standard change, or if a new billing code standard is adopted, embodiments of the present invention may use the techniques disclosed herein to generate relevant billing codes that are consistent with such changes automatically, i.e., without requiring modifications to the systems and methods disclosed herein, other than to update such systems and methods with knowledge of the new billing codes and/or standards. As a result, embodiments of the present invention provide a significant advantage over traditional printed superbills, which are effectively “hardwired” with a particular set of billing codes, and which must be manually redesigned and reprinted to reflect changes in billing codes and/or standards.

Furthermore, embodiments of the present invention provide a variety of benefits over traditional Computer Assisted Coding (CAC). CAC techniques attempt to automatically identify the most relevant codes to include in a bill based on available data. Such systems are subject to false positives (including billing codes that should not be included) and false negatives (failing to include codes that should be included). In contrast, embodiments of the present invention seek to assist human billing coders in selecting appropriate billing codes, not to replace such human billing coders. In particular, embodiments of the present invention combine the ability of an automated computer system to generate a relatively small, but still over-inclusive proposed set (e.g., the expanded billing code set 170) of billing codes quickly and easily, with the ability of a human billing coding expert to select the appropriate billing codes from such a set based on the billing coder's knowledge of the patient encounter, services rendered, and/or billing coding system. This combination of automation and human expertise is likely to strike a better balance between speed and accuracy than CAC systems.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

Although certain examples of billing code standards, such as ICD-9, ICD-10, and CPT are disclosed herein, these are merely examples and do not constitute limitations of the present invention. More generally, embodiments of the present invention may be used on connection with billing codes of any type and in any combination.

Although in the particular example described herein, the physician 104 both generates the clinical note 108 and selects billing codes for inclusion on a bill (by providing the billing code selection input 186), such functions need not be performed by the same person or entity. For example, a first person, such as a physician, may generate the clinical note 108, while a second person (not shown), such as a billing coding specialist, may select one or more billing codes to include on a bill based on the clinical note 108 by providing the billing code selection input 186.

Although in examples disclosed herein billing codes are generated based on a clinical note representing information related to a patient encounter, more generally the techniques disclosed herein may be used to generate billing codes based on any data representing a product and/or service provided to a subject. The subject may, for example, be a person or a legal entity (such as a corporation). The resulting billing codes may be included on a bill for the product and/or service provided to the subject.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor executing computer program instructions stored on at least one non-transitory computer-readable medium, the method comprising:
(A) generating an initial set of billing codes based on at least one document, wherein the at least one document describes an encounter with a patient;
(B) expanding the initial set of billing codes to include, in addition to the initial set of billing codes, billing codes related to the initial set of billing codes encoded according to a billing code standard, thereby creating an expanded set of billing codes;
(C) generating, based on the expanded set of billing codes, output representing the expanded set of billing codes, wherein the output includes content not encoded according to the billing code standard;
(D) providing, to a user, the output representing the expanded set of billing codes;
(E) receiving, from the user, input selecting a subset of the expanded set of billing codes, wherein the subset consists of fewer than all of the expanded set of billing codes; and
(F) generating a final set of billing codes, encoded according to the billing code standard, based on the subset selected by the user.

2. The method of claim 1, wherein the output omits content included within the expanded set of billing codes.

3. The method of claim 1, wherein the output includes content not included within the expanded set of billing codes.

4. The method of claim 1, wherein (E) comprises receiving, from the user, input in association with a portion of the output representing the expanded set of billing codes.

5. The method of claim 4, wherein the input in association with the portion of the output representing the expanded set of billing codes represents input selecting the portion of the output representing the expanded set of billing codes.

6. The method of claim 1, wherein the final set of billing codes does not include billing codes not contained within the subset selected by the user.

7. The method of claim 1, further comprising:
(F) before (A), generating the at least one document by transcribing speech of a user describing the encounter with the patient.

8. The method of claim 1, wherein (A) comprises generating the initial set of billing codes based on at least one clinical note describing the encounter with the patient and at least one electronic health record of the patient.

9. The method of claim 8, further comprising identifying the at least one electronic health record of the patient based on the at least one clinical note.

10. The method of claim 1, wherein (A) comprises generating the initial set of billing codes based on at least one clinical note describing the encounter with the patient, at least one electronic health record of the patient, and at least one electronic health record of a patient other than the patient.

11. The method of claim 1, wherein (A) comprises:
(A)(1) generating a seed set of billing codes;
(A)(2) filtering the seed set of billing codes based on the at least one document to produced a filtered set of billing codes; and
(A)(3) generating the initial set of billing codes based on the filtered set of billing codes.

12. The method of claim 11, wherein (A)(1) comprises generating the seed set of billing codes based on the at least one document.

13. The method of claim 11, wherein (A)(1) comprises generating the seed set of billing codes based on an electronic health record of the patient.

14. The method of claim 11, wherein the at least one document includes a plurality of encoded concepts, and wherein (A)(2) comprises removing, from the seed set of billing codes, billing codes not associated with any of the plurality of encoded concepts in the at least one document.

15. The method of claim 1, wherein the at least one document includes a plurality of encoded concepts, and wherein (A) comprises:
(A)(1) mapping the plurality of encoded concepts to a plurality of billing codes within the billing code standard; and
(A)(2) generating the initial set of billing codes based on the plurality of billing codes within the billing code standard.

16. The method of claim 1, wherein (B) comprises:
(B) (1) identifying, for each billing code C in the initial set of billing codes, based on the billing code standard, at least one billing code that is related to billing code C; and
(B) (2) adding the at least one billing code that is related to billing code C to the expanded set of billing codes.

17. The method of claim 1, wherein (E) comprises generating the final set of billing codes to contain solely the subset selected by the user.

18. The method of claim 1, further comprising:
(G) revising billing code extraction data based on the input selecting the subset of the expanded set of billing codes; and
(H) generating a further initial set of billing codes based on the at least one document and the revised billing code extraction data.

19. The method of claim 1, further comprising:
(G) receiving a modified version of the at least one document; and
(H) applying (A)-(F) to the modified version of the at least one document.

20. A system comprising at least one non-transitory computer-readable medium having computer program instructions stored thereon, wherein the computer program instructions are executable by at least one computer processor to perform a method, the method comprising:
(A) generating an initial set of billing codes based on at least one document, wherein the at least one document describes an encounter with a patient;
(B) expanding the initial set of billing codes to include, in addition to the initial set of billing codes, billing codes related to the initial set of billing codes encoded according to a billing code standard, thereby creating an expanded set of billing codes;
(C) generating, based on the expanded set of billing codes, output representing the expanded set of billing codes, wherein the output includes content not encoded according to the billing code standard;
(D) providing, to a user, the output representing the expanded set of billing codes;
(E) receiving, from the user, input selecting a subset of the expanded set of billing codes, wherein the subset consists of fewer than all of the expanded set of billing codes; and
(F) generating a final set of billing codes, encoded according to the billing code standard, based on the subset selected by the user.

21. The system of claim 20, wherein the output omits content included within the expanded set of billing codes.

22. The system of claim 20, wherein the output includes content not included within the expanded set of billing codes.

23. The system of claim 20, wherein (E) comprises receiving, from the user, input in association with a portion of the output representing the expanded set of billing codes.

24. The system of claim 23, wherein the input in association with the portion of the output representing the expanded set of billing codes represents input selecting the portion of the output representing the expanded set of billing codes.

25. The system of claim 20, wherein the final set of billing codes does not include billing codes not contained within the subset selected by the user.

26. The system of claim 20, wherein the method further comprises:
(F) before (A), generating the at least one document by transcribing speech of a user describing the encounter with the patient.

27. The system of claim 20, wherein (A) comprises generating the initial set of billing codes based on at least one clinical note describing the encounter with the patient and at least one electronic health record of the patient.

28. The system of claim 27, wherein the method further comprises identifying the at least one electronic health record of the patient based on the at least one clinical note.

29. The system of claim 20, wherein (A) comprises generating the initial set of billing codes based on at least one clinical note describing the encounter with the patient, at least one electronic health record of the patient, and at least one electronic health record of a patient other than the patient.

30. The system of claim 20, wherein (A) comprises:
(A)(1) generating a seed set of billing codes;
(A)(2) filtering the seed set of billing codes based on the at least one document to produced a filtered set of billing codes; and
(A) (3) generating the initial set of billing codes based on the filtered set of billing codes.

31. The system of claim 30, wherein (A)(1) comprises generating the seed set of billing codes based on the at least one document.

32. The system of claim 30, wherein (A)(1) comprises generating the seed set of billing codes based on an electronic health record of the patient.

33. The system of claim 30, wherein the at least one document includes a plurality of encoded concepts, and wherein (A)(2) comprises removing, from the seed set of billing codes, billing codes not associated with any of the plurality of encoded concepts in the at least one document.

34. The system of claim 20, wherein the at least one document includes a plurality of encoded concepts, and wherein (A) comprises:
(A)(1) mapping the plurality of encoded concepts to a plurality of billing codes within the billing code standard; and
(A)(2) generating the initial set of billing codes based on the plurality of billing codes within the billing code standard.

35. The system of claim 20, wherein (B) comprises:
(B)(1) identifying, for each billing code C in the initial set of billing codes, based on the billing code standard, at least one billing code that is related to billing code C; and
(B)(2) adding the at least one billing code that is related to billing code C to the expanded set of billing codes.

36. The system of claim 20, wherein (E) comprises generating the final set of billing codes to contain solely the subset selected by the user.

37. The system of claim 20, wherein the method further comprises:
(G) revising billing code extraction data based on the input selecting the subset of the expanded set of billing codes; and
(H) generating a further initial set of billing codes based on the at least one document and the revised billing code extraction data.

38. The system of claim 20, wherein the method further comprises:
(G) receiving a modified version of the at least one document; and
(H) applying (A)-(F) to the modified version of the at least one document.
